(19) United States
(12) Patent Application Publication
(10) Pub. No.: US 2002/0157500 A1
(43) Pub. Date: Oct. 31, 2002

(54) Built-up camshaft

(76) Inventors: Herbert Gropp, Chemnitz (DE); Dietmar Klose, Chemnitz (DE); Claus-Peter Durlich, Zwickau (DE); Manfred Janssen, Werdau (DE)

Correspondence Address: Horst M. Kasper, 13 Forest Drive, Warren, NJ, 07059, US

(21) Appl. No.: 09/476,521

(22) Filed: Jan. 3, 2000

Related U.S. Application Data
(63) Continuation of application No. 09/016,597, filed on Jan. 30, 1998, now abandoned.

(30) Foreign Application Priority Data
Jan. 30, 1997 (DE) 197 03 260.3

(51) Int. Cl. F16H 53/00

(52) U.S. Cl. 74/567

(57) ABSTRACT

A pipe or a solid rod (1) is coated on the outer surface, or cams (3) and/or other parts are coated on their inner surface with a suitable coating (2), for example a joint-stable conversion coating, in order to produce a cost-advantageous mass product with commercially available materials and semifinished materials by a longitudinal pressing on of cams and other parts onto the pipe or solid rod.

### BACKGROUND OF THE INVENTION

1. Field of the Invention

The present invention relates to a built-up camshaft including a pipe or a solid rod, cams, ring bearings, end pieces, and other parts.

2. Brief Description of the Background of the Invention Including Prior Art

Built-up camshafts are produced today essentially by a partial internal high-pressure deformation of the pipe against the cams, by elevating, raising, and advancing the surface of the pipe and squeezing the cams onto the pipe or by shrink-fitting the cams on the pipe.

The shaping of the cams from the pipe by internal high-pressure deformation is also being considered.

However, all of these production methods are accompanied with substantial disadvantages. The starting materials have to exhibit very low tolerances in regard to dimension and material characteristics and the joining technique is complicated. The internal high-pressure deformation is expensive and produces thin walls at exactly the important tips of the cams.

### SUMMARY OF THE INVENTION

1. Purposes of the Invention

Based on the state of the art, the present invention has the object to build a camshaft with commercially available materials and semifinished materials with a simple technology, wherein said camshaft is manufactured in mass production at an advantageous cost.

These and other objects and advantages of the present invention will become evident from the description which follows.

2. Brief Description of the Invention

The present invention provides for a camshaft according to the characterizing portion of claim 1.

Suitable embodiments of the invention are contained in the subclaims.

The attachment of the cams and of the other parts on the pipe is performed with a longitudinal compression joint. The pipe is coated, preferably with a finely crystalline phosphate coating, as known from the East German printed patent document 015 2972, such that the overdimensioned cams, which are to be slipped, do not score and seize, that the friction tightness is increased, and that no tribocorrosion is generated later on. Following a careful opening up in an automatic jointing machine, the cams are slid into their positions and, in fact, continuously without a stick-slip effect. The surface of the pipe or of the solid rod is thereby not affected and does not exhibit any scoring or scratches.

It is also possible to precisely carry out the fine positioning to +0.1 mm longitudinally and +/−10 angular minutes based on the coating. A pipe, a solid rod, cams and other parts, if they are pressed on longitudinally, require no particularly narrow dimension tolerances and material tolerances, but they can be used of a conventional quality. A torsional resistance of 10-20 Nm can be easily reached.

The exact positioning of each individual cam is assured by the longitudinal compression method on a suitably coated surface. Camshafts must also exhibit as a whole very small dimensions such that the two cams, spaced the farthest apart from one another, can exhibit relative to each other also only very low deviations from the ideal position. Therefore, an slight regrinding of the cam track surface is performed. The object is the “jointing and finishing” without regrinding, which has to grow out from and result from the experiences of mass production. This object is achievable with the object of the present invention.

All individual parts to be mounted on the pipe can be completely machined beforehand including the surface hardening.

Instead of the finely crystalline phosphate coating, it is also possible to use other surface coatings, such as metal and cement. In the case of cement, the formation of the front face to be slid on is of importance for the distribution of the adhesive on the pipe or the solid rod.

The coating can be performed on one side or on two sides on the pipe outer bore and/or cam inner bore.

The cams are appropriately formed of light-weight sheet metal construction, such as is for example known from the German printed patent document 196 40 872.5. The cams can however also be made of solid material, plastic or ceramic material. A drawn surface quality is sufficient for the pipe and also for the bearing seats. However, a regrinding of the bearing positions can be required for tolerance reasons.

### BRIEF DESCRIPTION OF THE DRAWINGS

In the accompanying drawings, in which are shown several of the various possible embodiments of the present invention:

FIG. 1 is a schematic sectional view through a camshaft segment;

FIG. 2 is a schematic sectional view through a camshaft end;

FIG. 3 is a view of the entire camshaft on a reduced scale.

### DESCRIPTION OF INVENTION AND PREFERRED EMBODIMENT

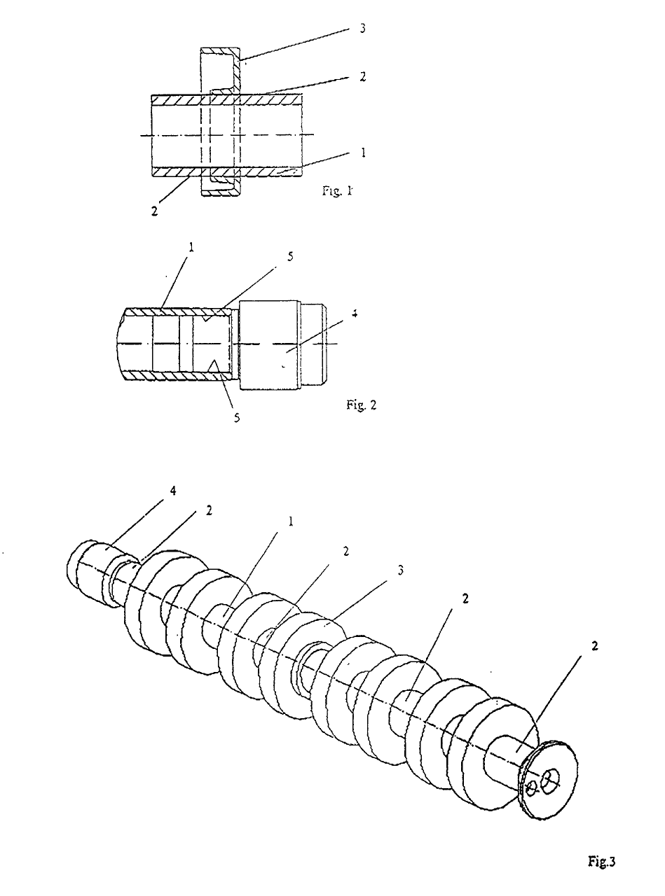

The jointing coating 2 between the pipe 1 and the cams 3 of light-weight sheet metal construction is indicated in FIG. 1. However, the jointing coating 2 in fact does not have a measurable radial extension.

In FIG. 2, the pipe has an inner coating 5, such that the end piece 4 can be pressed in.

FIG. 3 shows the entire camshaft, wherein all parts to be disposed on the pipe, are longitudinally pressed onto the camshaft. For simplicity's sake, the cams are represented as disks.

1. A built-up camshaft comprising
a pipe or a solid rod,
cams,
bearing rings,
end pieces, and
other parts, wherein the cams (3), the end pieces (6), the bearing rings, and the other parts are connected by means of longitudinal compression joints to the pipe or to the solid rod, wherein the parts to be connected are provided with a suitable surface coating, and wherein the surface coating prevents a tribocorrosion and increases the load capacity as compared to conventional compression joints.

2. The camshaft according to claim 1, wherein the coating (2, 5) is a joint-stable conversion coating.

3. The camshaft according to claim 1, wherein the coating (2, 5) is a metal coating or a cement coating.

4. The camshaft according to claim 1, wherein the pipe or the solid rod and/or the cams, the end pieces, the bearing rings, and the other parts are made out of metal, ceramics, plastics or other materials, by cutting or non-cutting, by milling or forging in massive or profiled form.

5. The camshaft according to claim 1, wherein the outer jacket face of the pipe or of the solid rod has a drawn quality or is completely or partially mechanically machined.
